(19) United States
(12) Patent Application Publication
(10) Pub. No.: US 2018/0276552 A1
(43) Pub. Date: Sep. 27, 2018

(54) VEHICLE USAGE PATTERN EVALUATION

(71) Applicant: Ford Global Technologies, LLC, Dearborn, MI (US)

(72) Inventors: Yimin Liu, Ann Arbor, MI (US); Perry Robinson MacNeille, Lathrup Village, MI (US); Dongfan Chen, Northville, MI (US); David Fraser, Marysville, MI (US); Paul Duncan McCarthy, Ann Arbor, MI (US); Alfredo Cateriano, Novi, MI (US)

(73) Assignee: Ford Global Technologies, LLC, Dearborn, MI (US)

(21) Appl. No.: 15/757,080

(22) PCT Filed: Sep. 29, 2015
(86) PCT No.: PCT/US2015/052784

§ 371 Date: Mar. 2, 2018

(51) Int. Cl. G06N 5/04

(52) U.S. Cl. CPC G06N 5/047; H04W 4/46

(57) ABSTRACT

A computing device includes a processing circuit and a data storage medium. The processing circuit is programmed to receive first vehicle usage data associated with a first user and second vehicle usage data associated with a second user. The processing device can identify a first pattern associated with the first vehicle usage data, identify a second pattern associated with the second vehicle usage data, and determine whether the first pattern is complementary to the second pattern.

### CROSS-REFERENCE TO RELATED APPLICATION

This patent application is filed under 35 U.S.C. § 371 as a national stage of, and as such claims priority to, International Patent Application No. PCT/US2015/052784, filed on 29 Sep. 2015, the foregoing application is incorporated herein by reference in its entirety.

### BACKGROUND

Car sharing or ride sharing programs allow users to temporarily rent or use a car for a short period of time. Such programs are beneficial to drivers or riders who occasionally need use of a vehicle but do not wish to purchase a vehicle. For example, someone who lives in an urban area within walking or biking distance of work and other frequently visited places (like a grocery store, gym, etc.) may occasionally use a car sharing or ride sharing program for those times when a vehicle is needed rather than purchase his or her own vehicle.

### BRIEF DESCRIPTION OF THE DRAWINGS

FIG. 1 illustrates an example computing device in communication with a mobile device for receiving vehicle usage data.

FIG. 2 is a block diagram showing example components of the computing device of FIG. 1.

FIG. 3 is a map showing example vehicle usage data and an example cluster based on the usage date.

FIG. 4 is a flowchart of an example process that may be executed by the computing device to cluster vehicle users according to the vehicle usage data.

### DETAILED DESCRIPTION

Some people only use their vehicles at certain times of the day. For instance, during the week, some people use their vehicle to drive between their home and place of employment. Between those times, the vehicle sits unused in a driveway or parking lot. Thus, for certain people, their vehicle is not being used the vast majority of the time.

This creates an opportunity for certain groups of people—such as people with complementary vehicle usage patterns—to share a commonly owned or leased vehicle. Complementary usage patterns may refer to usage patterns with little to no temporal overlap but with much geographic overlap. Also, besides time and location, the group may include users who typically need a certain type of vehicle (car, truck, SUV, etc.). By way of example, one group of people with complementary usage patterns could include a person who drives to work at 8:30 am and drives home at 5:30 pm, a person who works an overnight shift (e.g., 7 pm-7 am) at a local hospital, and a person who takes classes at a local college or university from 10 am-4 pm. Each person in the group may live or work near the others, and each may not need a vehicle much larger than a mid-sized sedan. Further, each person in the group may be within walking or biking distance of the vehicle at the time the vehicle is needed by each individual.

Benefits of a shared vehicle arrangement include increased access to a vehicle relative to a ride-sharing or car sharing program with a lower cost than individual vehicle ownership. Finding people with complementary usage patterns may help to maximize access and convenience of all of the members of the group. An example computing device that can help generate such groups (referred to below as “clusters”) includes a processing circuit and a data storage medium. The processing circuit is programmed to receive first vehicle usage data associated with a first user and second vehicle usage data associated with a second user. The processing device can identify a first pattern associated with the first vehicle usage data, identify a second pattern associated with the second vehicle usage data, and determine whether the first pattern is complementary to the second pattern. If the patterns are complementary, the processing circuit may group the users into the same cluster. The cluster can include any number of users, however, for practical purposes, having too many users may limit each user's access to the vehicle, especially during atypical or otherwise less structured time periods (weekends, holidays, etc.).

Procedures may be established for introducing new people to existing groups. For instance, a person looking to join a joint ownership group may use an application installed on his or her mobile device to find nearby others in joint vehicle ownership groups. The application may allow the user to contact group members looking for additional members to, e.g., arrange a meeting. The application may generate a route and turn-by-turn directions to the meeting place. If the current members of the group have certain criteria for new group members, the criteria may be displayed on the application, and setting up the meeting may require the prospective new group member to affirm that the criteria are met. The new group member's inclusion in the group may also be subject to third party confirmation that the criteria for inclusion in the group are met. Instead of an application on a mobile device, data related to vehicle usage and existing groups may be provided via a web interface.

The platform for implementing this concept may be distributed. That is, it may use computing devices on the vehicle system (CANbus) networks that are connected using vehicle-to-vehicle communication, an APIM (Accessory Protocol Interface Module), remote devices that are connected to the APIM through wireless connections and connected to a Content Delivery Network (CDN) and themselves through wireless networks. The CDN may include a large distributed system of servers deployed in multiple data centers across the Internet. Computation and storage may be distributed across computing entities in this platform.

The elements shown in the FIGS. may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

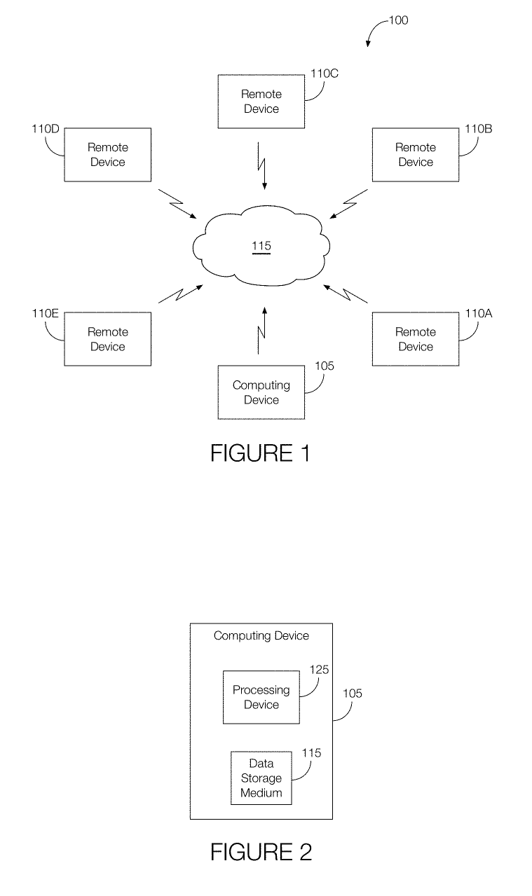

As illustrated in FIG. 1, a vehicle usage pattern identification system 100 includes a computing device 105 in communication with multiple remote devices 110A-110E, such as cell phones, tablet computers, or other electronic mobile devices with components, including circuits, programmed to capture vehicle usage data. The computing device 105 and remote devices 110A-110E may be in communication over a wireless communication network 115. The computing device 105 may be programmed to receive vehicle usage data associated with vehicle users. The vehicle usage data may include information about how a particular user uses a vehicle. Examples of vehicle usage data may include usage times, usage areas, preferred vehicle type, how many passengers etc. Usage time may refer to the days of the week and times of the day the user historically has used a vehicle. Usage areas may refer to the geographic areas in which the user has historically used a vehicle. Examples of usage areas may include a user's home location, work location, school location, etc. Preferred vehicle type may refer to the type of vehicle (coupe, sedan, SUV, truck, minivan, etc.) the user historically needs or prefers. Usage data may be collected by, e.g., the user's mobile device and transmitted to the computing device 105 via, e.g., a wireless communication network. The usage data may further identify whether the usage data was captured while the user was a vehicle driver or a vehicle passenger, as well as how much time the user spends as a driver or a passenger. Thus, for instance, the usage data may be identified via an in-vehicle APIM such as the Ford SYNC® application.

The computing device 105 may be programmed to collect usage data from multiple users and identify a usage pattern associated with each user. The usage pattern may generalize the usage data discussed above. For instance, one usage pattern may define the days and times the user is most likely to need to use the vehicle. Another usage pattern may define the geographic areas where the user is most likely to use the vehicle. Another usage pattern may define the type of vehicle the user generally prefers. Another usage pattern may define the routine routes where the use is most likely to use the vehicle.

The computing device 105 may be programmed to compare usage patterns among multiple users and identify which users have complementary usage patterns. Complementary usage patterns may include usage patterns where multiple users can generally fully use the vehicle. In other words, complementary usage patterns may include usage patterns where one user's use of the vehicle is not likely to interfere with another user's use of the vehicle. For instance, two users who do not typically need to use a vehicle at the same time may include a complementary usage pattern. If two users do need the vehicle around the same time (such as if both users need the vehicle to travel to and from work), their usage patterns may still be complementary if, for instance, the two users can carpool or ride-sharing (i.e., one user's home and work locations are near the other user's home and work locations).

Referring now to FIG. 2, the computing device 105 may include a data storage medium 120 and a processing circuit 125.

The data storage medium 120 may be programmed to store computer-executable instructions and possibly other data including vehicle usage data. For instance, the data storage medium 120 may include a database that relates vehicle usage data to particular users. Further, the database may include clusters that identify users with complementary usage patterns or similar usage patterns, as described in greater details below.

The processing circuit 125 may be programmed to access and execute the computer-executable instructions stored on the data storage medium 120. Moreover, the processing circuit 125 may be programmed to access and process the data stored in the database in the data storage medium 120. For instance, the processing circuit 125 may be programmed to receive vehicle usage data associated with a user, identify a pattern associated with the vehicle usage data, and determine whether that pattern is complementary to other patterns associated with other users.

For example, the processing circuit 125 may be programmed to extract usage times from the vehicle usage data. The usage times may include, e.g., periods of times that the user has historically used a vehicle, periods of times that a user is likely to use a vehicle, or the like. The processing circuit 125 may be programmed to determine whether the usage times overlap usage times of other users. Depending on the circumstances, overlapping or non-overlapping usage times may indicate complementary usage patterns. For instance, for ride-sharing, overlapping usage times indicate complementary usage patterns. For car sharing, non-overlapping usage times may indicate complementary usage patterns.

The usage areas may be non-Euclidean, i.e., the distance between points on the map may be defined by the travel cost between them (a combination of distance and time), and not necessarily by the geodetic (great circle) distance. For example, if a vehicle is moving south on a limited access divided highway and the next exit is 10 miles away, the distance to a vehicle 100 yards from the highway must be at least 20 miles and not 100 yards. The distance between routes (i.e. directed graphs in space and time) can be determined using the graph edit distance, which is also non-Euclidean.

The processing circuit 125 may additionally be programmed to extract a usage area from the usage data. The usage area may refer to the geographic location in which the user uses a vehicle. The processing circuit 125 may be programmed to determine whether the usage area at least partially overlaps usage areas of other users. Overlapping usage areas may indicate complementary usage patterns. The more overlap, the greater likelihood that the usage patterns are complementary. Thus, the processing circuit 125 may be programmed to determine whether the usage areas overlap by a predetermined amount, e.g., at least 50% overlap. In some possible approaches, the processing circuit 125 may be programmed to compare usage areas at particular times. For instance, the processing circuit 125 may be programmed to determine whether the usage areas overlap by a predetermined amount during a predetermined period of time, e.g., at least 70% overlap during handoff periods (i.e., the period of time when the next user would likely take possession of the vehicle) but no overlap is needed during other times.

The processing circuit 125 may be programmed to compare different types of usage areas relative to the handoff period. For instance, a handoff could occur when one user's home location is near another user's work location so long as their use of the vehicle is complementary. Therefore, the processing circuit 125 may compare the overlap between a first user's home location and a second user's work location to determine whether the vehicle usage is complementary. As discussed above, whether usage patterns are complementary may be based on the type of sharing. For instance, for ride sharing, complementary usage patterns are high intersected in time and space. For car sharing (users are using the vehicle at different times), complementary usage patterns are high disjoint.

The processing circuit 125 may be programmed to generate clusters from the usage data stored in the database. Specifically, the processing circuit 125 may generate the clusters to include users that have complementary usage patterns for car-sharing or similarity usage patterns for ride-sharing. Once a user has been associated with a cluster, the processing circuit 125 may update the database to relate the user and the cluster. The processing circuit 125 may be programmed to periodically update the clusters as new vehicle usage data is collected and processed. That is, the clusters may be periodically reevaluated when, e.g., one or more users in a cluster no longer wish to share vehicle usage.

When a cluster is generated or updated, the processing circuit 125 may be programmed to generate a notification to the users associated with the cluster. The notification may provide each user's contact information to the other users. Examples of contact information may include name, telephone number, email address, mailing address, or the like. The notification may further include instructions for participating in the joint vehicle usage program including the times at which each person can use the vehicle, the locations where handoffs can occur, procedures for modifying the joint usage arrangement, etc. If one user wishes to no longer participate in the joint usage arrangement, the processing circuit 125 may be programmed to identify other users with similar usage patterns of the person who no longer wishes to remain in the cluster or with complementary usage patterns to the persons who remain in the cluster.

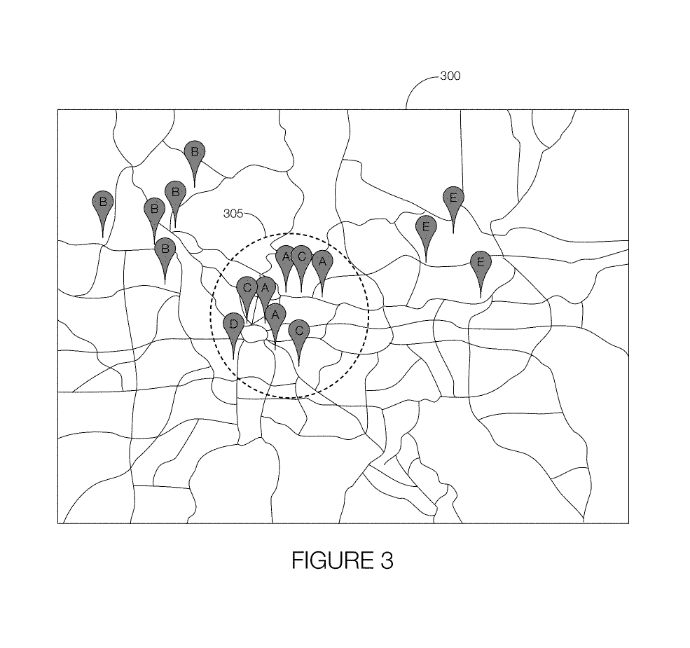

FIG. 3 illustrates a map 300 with example vehicle data that can be used to form clusters. Each “pin” in the map 300 has a letter, and pins with the same letter indicate locations of the same user. While only certain locations are shown, examples of the usage data may also or alternatively include, e.g., usage times, preferred vehicle type, whether the user was a passenger or a driver, etc. The map 300 may show all locations a particular user travels, and a cluster 305 may be formed by grouping users with the most complementary usage patterns. The cluster 305 includes users A, C, and D. The other users (users B and E) may be grouped into other clusters after more vehicle usage data has been received and evaluated.

The map 300 may be stored in a database located on a remote (e.g., cloud-based) server, in the computing device 105. In some instances, the remote server may communicate in accordance with a cloud-based content delivery network. The map 300 may be periodically updated incrementally (e.g., as new data is received), and only the parts of the database that have changed may be updated. As discussed above, the database may relate data to facilitate searching non-Euclidean spaces.

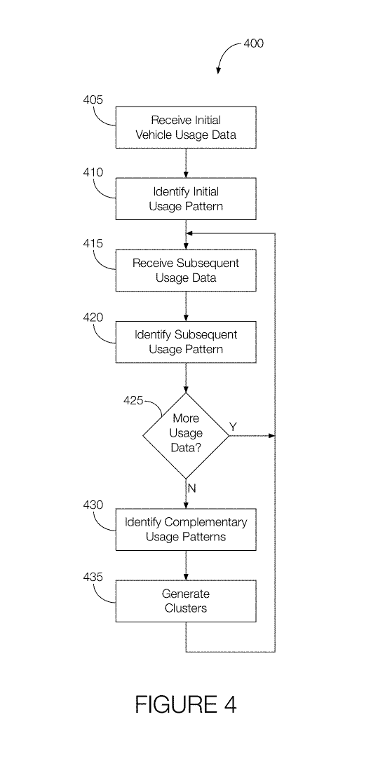

FIG. 4 is a flowchart of an example process 400 that may be executed by the computing device 105 to cluster vehicle users according to the vehicle usage data. The process 400 may be executed at any time after vehicle data has been collected.

At block 405, the computing device 105 may receive vehicle usage data (e.g., “first vehicle usage data”) associated with a first user. The vehicle usage data may include usage times, usage areas, preferred vehicle type, etc. Usage time may refer to the days of the week and times of the day the user historically has used a vehicle. Usage areas may refer to the geographic areas in which the user has historically used a vehicle. Examples of usage areas may include a user's home location, work location, school location, etc. Preferred vehicle type may refer to the type of vehicle (coupe, sedan, SUV, truck, minivan, etc.) the user historically needs or prefers. Usage data may be collected by, e.g., the user's mobile device and transmitted to the computing device 105 via, e.g., a wireless communication network. The usage data may further identify whether the usage data was captured while the user was a vehicle driver or a vehicle passenger, as well as how much time the user spends as a driver or a passenger.

At block 410, the computing device 105 may identify a pattern associated with the first usage data. For instance, the computing device 105 may generalize the first vehicle usage data received at block 405. The usage pattern, therefore, may define the days and times the user associated with the first vehicle usage data is most likely to need to use the vehicle, the geographic areas where the user associated with the first vehicle usage data is most likely to use the vehicle, the type of vehicle the user associated with the first vehicle usage data generally prefers, etc.

At block 415, the computing device 105 may receive vehicle usage data (e.g., “subsequent usage data”) associated with a different user. As with the first vehicle usage data, the subsequent usage data may include usage times, usage areas, preferred vehicle type, etc., associated with the other user.

At block 420, the computing device 105 may identify a pattern associated with the subsequent vehicle usage data received at block 415. The usage pattern determined at block 420 may define the days and times the user associated with the subsequent vehicle usage data is most likely to need to use the vehicle, the geographic areas where the user associated with the subsequent vehicle usage data is most likely to use the vehicle, the type of vehicle the user associated with the subsequent vehicle usage data generally prefers, etc.

At decision block 425, the computing device 105 may determine whether more vehicle usage data is to be evaluated. If so, the process 400 may return to block 415 so that additional vehicle usage data can be received and additional usage patterns identified. If the computing device 105 has a sufficient amount of information, or there is no additional vehicle usage data to evaluate, the process 400 may proceed to block 430.

At block 430, the computing device 105 determine whether any of the usage patterns are complementary to one another. For instance, the computing device 105 may determine whether the first usage pattern is complementary to any of the subsequent usage patterns, or if any of the subsequent usage patterns are complementary to one another. Depending on the context, complementary usage patterns may refer to usage patterns with little to no temporal overlap but with much geographic overlap. For instance, this may be true for car-sharing programs. Alternatively, such as the case for ride-sharing, complementary usage patterns may refer to usage patterns with significant temporal and geographic overlap. Also, besides time and location, the group may include users who typically need a certain type of vehicle (car, truck, SUV, etc.). Complementary usage patterns, therefore, may include usage patterns where one user's use of the vehicle is not likely to interfere with another user's use of the vehicle. For instance, two users who do not typically need to use a vehicle at the same time may include a complementary usage pattern. If two users do need the vehicle around the same time (such as if both users need the vehicle to travel to and from work), their usage patterns may still be complementary if, for instance, the two users can carpool (i.e., one user's home and work locations are near the other user's home and work locations). Further, the more geographic overlap in the usage patterns, the more likely it is that the usage patterns are complementary. Thus, determining whether the usage patterns are complementary may include determining whether the geographic areas associated with the usage patterns overlap by a predetermined amount.

At block 435, the computing device 105 may use the complementary usage patterns to generate a cluster. The cluster may identify each user associated with the complementary usage patterns, and the cluster may be stored in a database. From block 435, the process 400 may proceed to block 415 so that additional vehicle usage data may be processed. Any additional vehicle usage data may be used to form new clusters or update the users in a previously-formed cluster.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems (a subsidiary of BlackBerry Limited). Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising a processor and a memory, wherein the processor is programmed to receive first vehicle usage data associated with a first user and second vehicle usage data associated with a second user, identify a first pattern associated with the first vehicle usage data, identify a second pattern associated with the second vehicle usage data, and determine whether the first pattern is complementary to the second pattern.

2. The computing device of claim 1, wherein the first vehicle usage data includes a first usage time and the second vehicle usage data includes a second usage time, and wherein determining whether the first pattern is complementary to the second pattern includes determining whether the first usage time is different from the second usage time.

3. The computing device of claim 2, wherein the first usage time includes a period of time over which the first user historically uses a vehicle and wherein the second usage time includes a period of time over which the second user historically uses a vehicle.

4. The computing device of claim 1, wherein the first vehicle usage data includes a first usage area and the second vehicle usage data includes a second usage area, and wherein determining whether the first pattern is complementary to the second pattern includes determining whether the first usage area overlaps the second usage area.

5. The computing device of claim 4, wherein determining whether the first usage area overlaps the second usage area includes determining whether the first usage area overlaps the second usage area by at least a predetermined amount.

6. The computing device of claim 5, wherein the first usage area includes at least one of a home location and work location associated with the first user, and wherein the second usage area includes at least one of a home location and a work location associated with the second user.

7. The computing device of claim 1, wherein the processor is programmed to generate a cluster identifying the first user and the second user if the first pattern is complementary to the second pattern.

8. The computing device of claim 7, wherein the processor is programmed to receive third vehicle usage data associated with a third user, identify a third pattern associated with the third vehicle usage data, and determine whether the third pattern is complementary to at least one of the first pattern and the second pattern.

9. The computing device of claim 8, wherein the processor is programmed to generate the cluster to identify the third user if the third pattern is complementary to at least one of the first pattern and the second pattern.

10. The computing device of claim 1, wherein the first vehicle usage data indicates an amount of time the first user is a vehicle driver or a vehicle passenger, and wherein the second vehicle usage data indicates an amount of time the second user is a vehicle driver or a vehicle passenger.

11. A method comprising:
receiving first vehicle usage data associated with a first user;
receiving second vehicle usage data associated with a second user;
identifying a first pattern associated with the first vehicle usage data;
identifying a second pattern associated with the second vehicle usage data; and
determining whether the first pattern is complementary or similar to the second pattern.

12. The method of claim 11, wherein the first vehicle usage data includes a first usage time and the second vehicle usage data includes a second usage time, and wherein determining whether the first pattern is complementary to the second pattern includes determining whether the first usage time is different from the second usage time.

13. The method of claim 12, wherein the first usage time includes a period of time over which the first user historically uses a vehicle and wherein the second usage time includes a period of time over which the second user historically uses a vehicle.

14. The method of claim 11, wherein the first vehicle usage data includes a first usage area and the second vehicle usage data includes a second usage area, and wherein determining whether the first pattern is complementary to the second pattern includes determining whether the first usage area overlaps the second usage area.

15. The method of claim 14, wherein determining whether the first usage area overlaps the second usage area includes determining whether the first usage area overlaps the second usage area by at least a predetermined amount.

16. The method of claim 15, wherein the first usage area includes at least one of a home location and work location associated with the first user, and wherein the second usage area includes at least one of a home location and a work location associated with the second user.

17. The method of claim 11, further comprising generating a cluster identifying the first user and the second user if the first pattern is complementary to the second pattern.

18. The method of claim 17, further comprising:
receiving third vehicle usage data associated with a third user,
identifying a third pattern associated with the third vehicle usage data; and
determining whether the third pattern is complementary to at least one of the first pattern and the second pattern.

19. The method of claim 18, further comprising generating the cluster to identify the third user if the third pattern is complementary to at least one of the first pattern and the second pattern.

20. The method of claim 11, wherein the first vehicle usage data indicates an amount of time the first user is a vehicle driver or a vehicle passenger, and wherein the second vehicle usage data indicates an amount of time the second user is a vehicle driver or a vehicle passenger.
